(19) United States
(12) Patent Application Publication
(10) Pub. No.: US 2015/0103025 A1
(43) Pub. Date: Apr. 16, 2015

(54) INFORMATION PROCESSING DEVICE, METHOD AND PROGRAM

(71) Applicant: NEC Personal Computers, Ltd, Tokyo (JP)

(72) Inventors: Yoichiro Yamanaka, Tokyo (JP); Jun Yoshida, Tokyo (JP)

(73) Assignee: NEC Personal Computers, Ltd, Tokyo (JP)

(21) Appl. No.: 14/511,758

(22) Filed: Oct. 10, 2014

(30) Foreign Application Priority Data
Oct. 11, 2013 (JP) 2013-213760

(51) Int. Cl. G06F 3/041; G06F 3/0488; G06F 3/0484

(52) U.S. Cl. CPC G06F 3/041; G06F 3/04842; G06F 3/0488; G06F 2203/04104
USPC 345/173

(57) ABSTRACT

An extended display utilization environment is provided that permits comfortable operation. An information processing device includes: a touch panel 101 for detecting a plurality of operation input points; and extended operation means 108 for, when a plurality of operation input points have simultaneously been detected on the touch panel 101, on the basis of the plurality of detected operation input points, controlling an object displayed on an external display 102.

### BACKGROUND OF THE INVENTION

1. Field of the Invention

The present invention relates to an information processing device, a method, and a program and, in particular, to those displaying a screen of an application onto an external display.

2. Related Art

Patent Document 1 discloses a technique that drag and drop operation is abstracted and then, when a thumbnail such as a video image is dragged and dropped onto a predetermined icon, an application is started so that full screen display is performed on a secondary display. Further, Patent Document 2 discloses a technique relative to a multipoint technique in a touch panel.

Patent Document 1 Japanese Patent Laid-Open Publication No. 2010-528368

Patent Document 2 Japanese Patent Laid-Open Publication No. 2009-525538

### SUMMARY OF THE INVENTION

A technique that a screen of an application is expanded on a secondary display other than a main display is disclosed in Patent Document 1. Nevertheless, when the main display is premised to be a touch panel capable of multi-touch, information processing is performed not in a state that the function of the graphical user interface controlling the display on the secondary display is satisfactorily utilized.

The present invention has been devised in view of the above-mentioned situation. An object thereof is to provide an extended display utilization environment that permits comfortable operation.

The present invention devised for achieving the above-mentioned object is characterized by an information processing device comprising: a touch panel for detecting a plurality of operation input points; and extended operation means for, when a plurality of operation input points have simultaneously been detected on the touch panel, on the basis of the plurality of detected operation input points, controlling an object displayed on an external display.

According to the present invention, an extended display utilization environment can be provided that permits comfortable operation.

### BRIEF DESCRIPTION OF THE DRAWINGS

FIG. 1 is a diagram showing an exemplary configuration of external appearance according to an embodiment of the present invention.

FIG. 2 is a block diagram showing an example of hardware and software configuration of an information processing device 100 shown in FIG. 1.

FIG. 3 is a functional block diagram according to the above-mentioned embodiment.

FIG. 4 is a diagram showing an example of a display screen constructed according to the above-mentioned embodiment.

FIG. 5 is a flow chart showing a flow of operation input processing in an extended display utilization environment according to the above-mentioned embodiment.

FIG. 6 is a flow chart showing a flow of operation input processing according to another embodiment.

### DESCRIPTION OF THE EMBODIMENTS

### First Embodiment

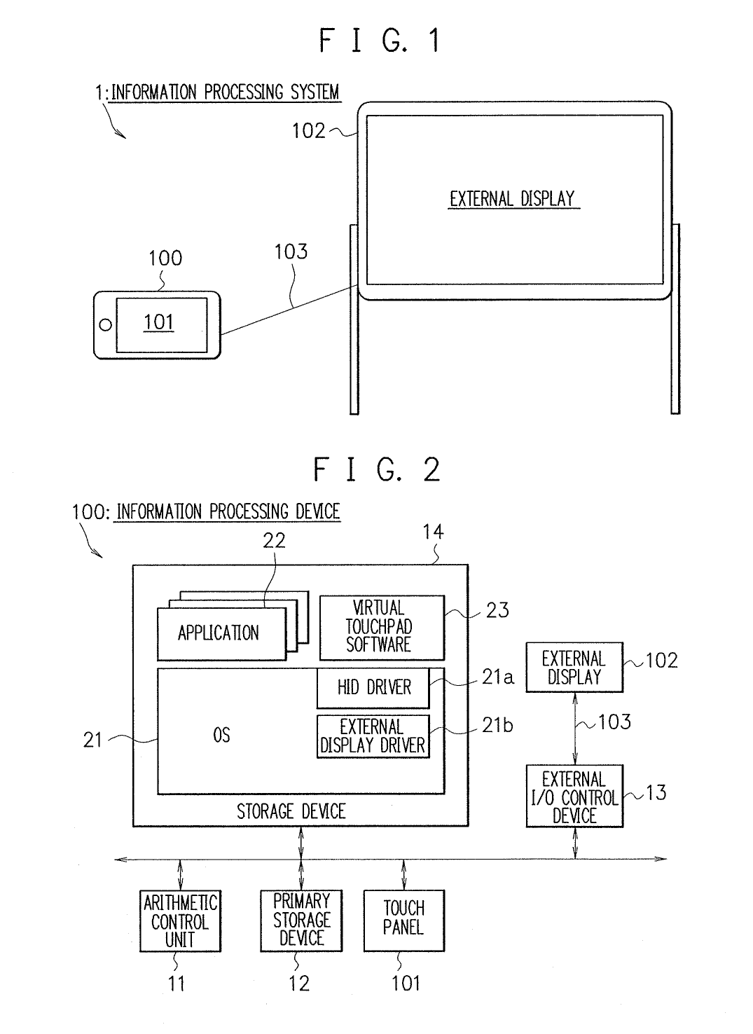

FIG. 1 shows an exemplary configuration of external appearance according to the present embodiment. As shown in the figure, an information processing system 1 according to the present embodiment may be constructed as a computer system including: an information processing device 100 constructed from a personal computer of tablet type (a tablet PC, hereinafter); and an external display 102. The type of display device employed in the external display 102 may be of diverse type such as a liquid crystal type and an organic electroluminescence type. The information processing device 100 and the external display 102 are connected in a manner of permitting mutual communication. Employable methods of communication are not limited to a particular one and the connection in the physical layer may be established, for example, through a display cable 103 as shown in the figure.

FIG. 2 shows an example of hardware and software configuration of the information processing device 100. In the information processing device 100, as the hardware, for example, a configuration may be employed that an arithmetic control unit 11, a primary storage device 12, an external I/O control device 13, a storage device 14, and a touch panel 101 are connected to each other through an internal bus. The external I/O control device 13 can perform input and output concerning the external display 102 through the display cable 103.

The storage device 14 stores a software program group used for perform information processing performed by the above-mentioned hardware. Such software includes an operating system (OS, hereinafter) 21, applications 22 which are various application software programs, and virtual touchpad software 23. As a part of the functions of the OS 21, a human interface device (HID, hereinafter) driver 21a and an external display driver 22b may also be included. The latter provides an interface used when the OS 21 operates the external display 102.

Here, the example of software configuration given above is an example adopted for description and may be modified variously. For example, the software may be provided by SaaS through a network. In the information processing achieved by the software program using the above-mentioned hardware, functional blocks described below are constructed. Further, the information processing is performed in accordance with a flow described later.

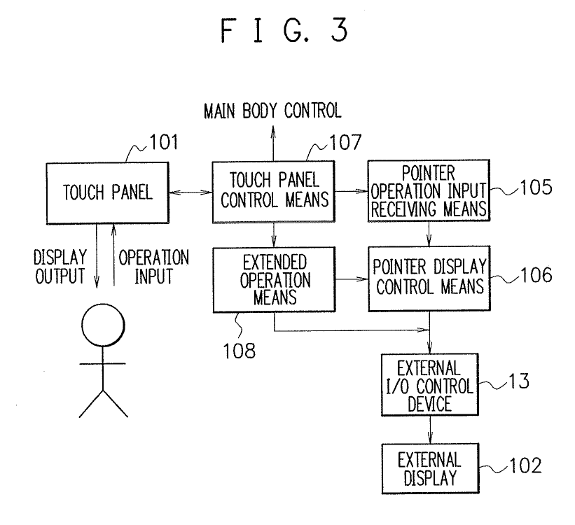

FIG. 3 shows a functional block diagram of the present embodiment. As shown in the figure, the information processing device 100 includes a touch panel 101, touch panel control means 107, extended operation means 108, pointer operation input receiving means 105, and pointer display control means 106.

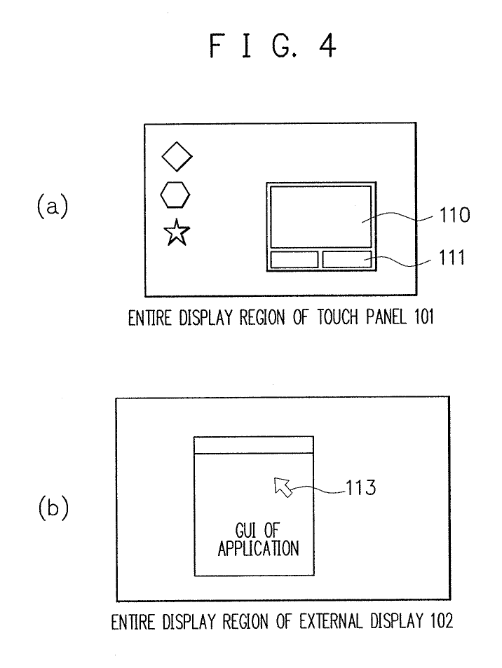

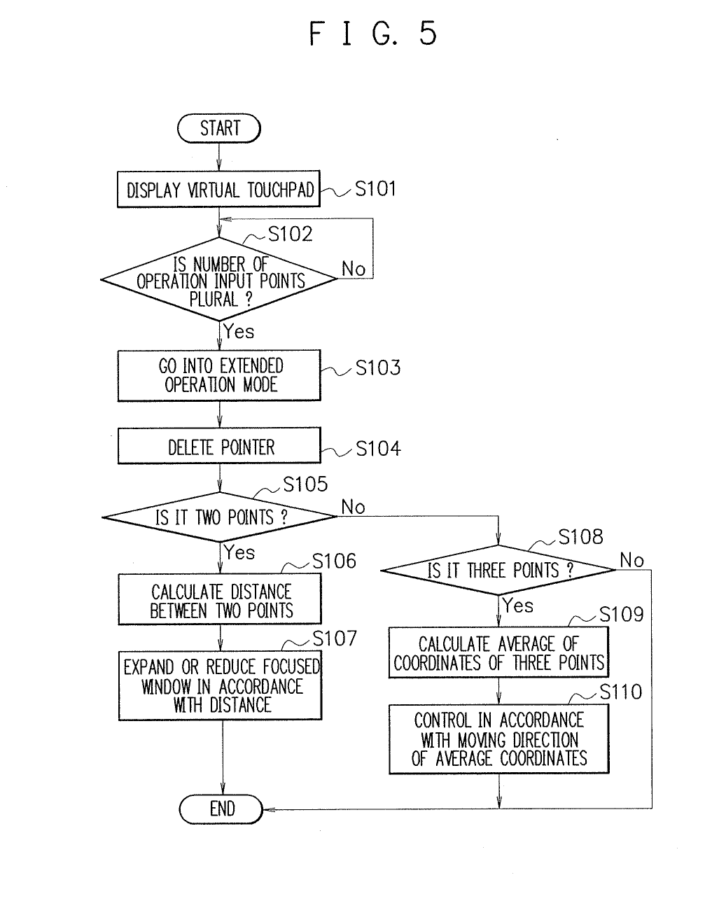

For example, the touch panel 101 is of electrostatic type and serves as display means as well as operation input means. FIG. 4 shows an example of a display screen according to the present embodiment. In the present embodiment, when the virtual touchpad software 23 is started, a virtual touchpad 110 shown in FIG. 4(a) is displayed on the touch panel 101. It is preferable that, as shown in FIG. 4(a), the virtual touchpad 110 is displayed such as to occupy a fixed area within the entire display region of the touch panel 101. Preferably, the virtual touchpad 110 includes function keys 111. The function keys 111 are assigned to right click and left click.

Further, the virtual touchpad software 23 recognizes operation input to the entire display region of the touch panel 101. The virtual touchpad software 23 provides a graphical user interface of the virtual touchpad 110 and also monitors operation input to a display region obtained by subtracting the virtual touchpad 110 from the entire display region. This display region may be regarded as a transparent region.

Operation input performed to the predetermined region where the virtual touchpad 110 is displayed is received by the pointer operation input receiving means 105. When the number of operation input points is 1, the pointer display control means 106 has the function of perform the control of displaying a pointer 113 on the display screen of the external display 102. The pointer 113 is a pointer cursor in a graphical user interface (GUI, hereinafter) provided by the OS 21.

Specifically, the OS 21 generates a secondary display on a virtual desktop and then generates therein a screen of the application 22 to be started. Further, the pointer display control means 106 generates also a pointer image. A display driver (not shown) unifies both so as to generate a screen of the external display 102. Then, the external display 102 performs actual display.

FIG. 4(b) shows an example of a display screen of the external display 102. In the extended display of the external display 102, a pointer 113 absent in the touch panel 101 is displayed. Further, a window of the application 22 having been started is displayed.

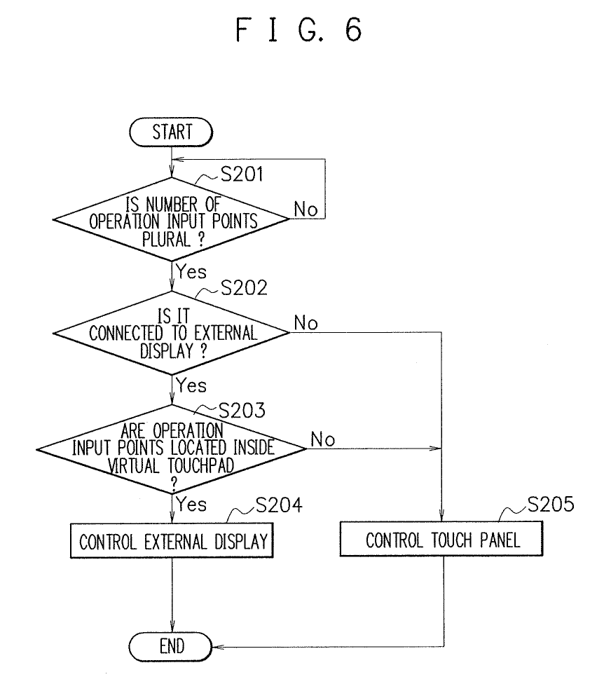

FIG. 5 shows a flow of operation input processing in the extended display utilization environment. The touch panel control means 107 displays the virtual touchpad 110 in a part of the region of the touch panel 101 (S101). Operation input is detected by the touch panel 101. Here, when a plurality of operation input points are detected, in the present embodiment, the mode goes into an “extended operation mode” and then information processing described below which is a feature of the present invention is performed (S102, S103).

First, under the control of the extended operation means 108, the pointer display control means 106 deletes the pointer 113 displayed on the external display 102 (S104). This improves visibility and hence operability. Then, the coordinates detected by the touch panel 101 are inputted to the extended operation means 108 continuously.

First, the extended operation means 108 judges whether the number of operation input points having been detected as being a plurality is equal to a first predetermined number (S105). In the present embodiment, the first predetermined number is premised to be “2”.

In case of Yes at S105, the extended operation means 108 calculates the distance between the two points and then, in accordance with the change in the distance between the two points, expands or reduces a drawn object displayed on the external display 102 (S106, S107).

Preferably, the drawn object serving as a target of this control is an active window focused in the GUI. However, another object may be adopted. In the following description, the object is premised to be a so-called active window focused among the objects drawn on the external display 102. Further, as the contents of the control, in addition to expansion or reduction, the size of the window may be changed or, alternatively, the contents displayed in the window may be displayed larger or smaller.

In case of No at S105, the extended operation means 108 judges whether the number of operation input points having been detected as being a plurality is equal to a second predetermined number (S108). In the present embodiment, the second predetermined number is premised to be “3”.

In case of Yes at S108, the extended operation means 108 calculates the average of the coordinates of the three points (S109) and then monitors the moving direction of the calculated average coordinates so as to perform control in accordance with the moving direction (S110).

For example, when the moving direction is upward, the active window is changed. The extent of overlap between the active window and the window in the secondary display is recognized by the OS 21. For example, the moving direction is downward, the control of closing the present active window is performed. Here, in the present embodiment, the coordinates determined on the basis of the coordinates of the three points have been adopted as the average coordinates. However, employable approaches are not limited to this. That is, the orthocenter, the center of the circumscribed circle, the center of the inscribed circle, or the like may be adopted.

According to the embodiment described above, an extended display utilization environment can be provided that permits comfortable operation. In particular, even when the external display 102 is not capable of multi-touch, control can be performed in a state that the multi-touch function of the information processing device 100 constructed from a tablet PC is utilized. This provides remarkable convenience.

### Second Embodiment

In the first embodiment, it has been premised that the external display 102 is connected to the information processing device 100. Instead, in the present embodiment, a flow of operation input processing applicable even in case of not being connected is described below. FIGS. 1 to 4 of the first embodiment are valid also in the present embodiment. FIG. 6 shows the flow of operation input processing according to the present embodiment.

In the present embodiment, first, the touch panel control means 107 judges whether the number of operation input points detected by the touch panel 101 is plural (S201). In case of not being plural, that is, in case of single touch, the situation is not specific to the present embodiment and hence its description is omitted. In case of being plural, then, the touch panel control means 107 transfers the processing to the extended operation means 108. Then, the extended operation means 108 judges whether the information processing device 100 is presently connected to the external display 102 (S202).

In case of not being connected, the extended operation means 108 judges that the operation input based on the plurality of operation input points is operation input to the GUI displayed on the touch panel 101, and then transfers the processing to the OS 21. The OS 21 controls the touch panel 101 (S205).

On the other hand, in case of being connected, then, the extended operation means 108 judges whether the operation input points are located inside the region of the virtual touchpad 110 (S203). In a case that the virtual touchpad software 23 is not started and hence the virtual touchpad 110 is not drawn, “No” is concluded at S203 and hence touch panel control is performed (S205).

As for the judgment whether the operation input points are located inside the region of the virtual touchpad 110, for example, “Yes” may be concluded when all points are located inside. Alternatively, “Yes” may be concluded when at least one point is located inside. In such a case, the extended operation means 108 judges that the operation input based on the plurality of operation input points is control to the object drawn on the external display 102, and then executes the control (S204). The detailed contents of the control is the same as those in the first embodiment.

According to the present embodiment described above, without the necessity of checking the connection of the external display 102, control can be performed in a state that the multi-touch function of the information processing device 100 constructed from a tablet PC is utilized. This provides a feeling of comfortable extended operation.

This application is based upon and claims the benefit of priority from Japanese patent application No. 2013-213760, filed on Oct. 11, 2013, the disclosure of which is incorporated herein its entirety by reference.

### DESCRIPTION OF REFERENCE NUMERALS

1 Information processing system

100 Information processing device (tablet PC)

101 Touch panel

102 External display

103 Display cable

105 Pointer operation input receiving means

106 Pointer display control means

107 Touch panel control means

108 Extended operation means

110 Virtual touchpad

113 Pointer

What is claimed is:

1. An information processing device comprising:
a touch panel for detecting a plurality of operation input points; and
extended operation means for, when a plurality of operation input points have simultaneously been detected on the touch panel, on the basis of the plurality of detected operation input points, controlling an object displayed on an external display.

2. The information processing device according to claim 1, wherein even in a case that a plurality of operation input points have simultaneously been detected on the touch panel, when the external display is not connected to the information processing device, the extended operation means recognizes the operation input based on the plurality of detected operation input points, as control onto an object displayed in the display region of the touch panel.

3. The information processing device according to claim 1, comprising
touch panel control means of performing control of displaying a virtual touchpad in a first region serving as a part of an entire display region of the touch panel, wherein
in a case that a plurality of operation input points have simultaneously been detected on the touch panel, when at least one operation input point is located in the first region, the extended operation means recognizes the operation input based on the plurality of operation input points simultaneously detected on the touch panel, as control onto an object displayed on the external display.

4. The information processing device according to claim 3, wherein in a case that a plurality of operation input points have simultaneously been detected on the touch panel, when all operation input points are located in the first region, the extended operation means recognizes the operation input based on the plurality of operation input points simultaneously detected on the touch panel, as control onto an object displayed on the external display.

5. The information processing device according to claim 1, wherein the object displayed on the external display is a window focused in a graphical user interface displayed on the external display.

6. The information processing device according to claim 1, wherein when the number of the operation input points is equal to a first number, the extended operation means performs control in accordance with a distance between the operation input points.

7. The information processing device according to claim 1, wherein when the number of the operation input points is equal to a second number, the extended operation means performs control in accordance with a moving direction of the coordinates determined on the basis of the number of the operation input points which is equal to the second number.

8. The information processing device according to claim 1, wherein when a plurality of operation input points have been detected on the touch panel, the extended operation means performs display control of deleting a pointer displayed on the external display.

9. An information processing method executed by a computer provided with a touch panel, comprising:
a step of detecting a plurality of operation input points on the touch panel; and
an extended operation step of, on the basis of the plurality of detected operation input points, controlling an object displayed on an external display.

10. A program for causing a computer provided with a touch panel to execute:
processing of detecting a plurality of operation input points on the touch panel; and
extended operation processing of on the basis of the plurality of detected operation input points, controlling an object displayed on an external display.
